(19) United States
(12) Patent Application Publication
(10) Pub. No.: US 2012/0296737 A1
(43) Pub. Date: Nov. 22, 2012

(54) METHOD AND SYSTEM FOR DIVIDING AND TRADING EMISSION REDUCTION CREDITS BETWEEN LINKED WEBSITES AND ADVERTISERS

(75) Inventor: Ian Leo Wolff, Nuevo Leon (MX)

(73) Assignee: Save The Planet and Win, LLC, San Francisco, CA (US)

(21) Appl. No.: 13/368,243

(22) Filed: Feb. 7, 2012

Related U.S. Application Data
(60) Provisional application No. 61/487,416, filed on May 18, 2011.

(51) Int. Cl. G06Q 30/02; G06Q 40/04

(52) U.S. Cl. 705/14.49; 705/14.73

(57) ABSTRACT

A method and system for dividing and trading of emission reduction credits between linked websites and advertisers is provided. A general emission reduction credit inventory and Portfolios with emission reduction credits can be created in a Sustainable Ad Network platform. The emission reduction credits of the inventory or Portfolios can be divided into micro emission reduction credits. A website or advertiser can be linked to the Sustainable Ad Network platform and a unique emission reduction credit account can be created for each linked website, advertiser or person. A sustainable advertisement can be associated to each linked website, and the sustainable advertisement can be placed on each linked website. When a person clicks, views, or interacts with a sustainable advertisement, micro emission reduction credits can be subtracted from the general emission reduction credits inventory, and added or credited to the emission reduction credit account of the website, advertiser or person.

### CROSS-REFERENCE TO RELATED APPLICATION

This application claims priority to U.S. Provisional Application No. 61/487,416, filed May 18, 2011, entitled “METHOD AND SYSTEM FOR DIVIDING AND TRADING EMISSION REDUCTION CREDITS BETWEEN LINKED WEBSITES”, and is incorporated herein by reference in its entirety.

### TECHNICAL FIELD OF THE INVENTION

The invention relates to a method and system for dividing and trading of emission reduction credits between linked websites and advertisers based on the interaction with online advertisements.

### BACKGROUND OF THE INVENTION

Greenhouse gases such as carbon dioxide are thought to be responsible for climate change. Currently, many business activities, including marketing, result in the direct and indirect emissions of greenhouse gases.

The majority of marketing campaigns are now done without any regard as to the amount of carbon dioxide or other greenhouse gas released. However, it is anticipated that in the future, consumers may be disinclined to accept the services or products of a company whose marketing campaigns have not been audited for associated greenhouse gas emissions.

Furthermore, with the introduction of various government measures such as, for example, a carbon pollution reduction scheme, a greenhouse gas cap and trade scheme, or a carbon tax, the carbon dioxide that is associated with a marketing campaign may directly translate to a cost to an, organization paying for the campaign. Offsetting emissions with carbon offset credits also costs money. Anticipating emissions may allow a reduction in these costs. The quantity of offset credits needed for a marketing campaign may require anticipation of these emissions.

Pressure to reduce greenhouse gas emissions may also come from the community, a stakeholder, or a shareholder. These entities may prefer or even demand that greenhouse gas emissions be accounted for, and possibly offset.

Greenhouse gas emissions are often overlooked. Greenhouse gas emissions are associated with almost all forms of advertising. For example, in the case of online advertising, greenhouse gases are generated indirectly through electricity use whenever a user views or interacts with an online advertisement embedded on a web page.

Marketers tend to have a simplistic strategy of moving from paper-based communications to going online to reduce greenhouse gas emissions. However, this is too simplistic. A basic national buyer of a banner ad on a top search engine will give the advertiser over 700,000 views delivered per day. These views may add up to over 7 tons of carbon dioxide or equivalent entering the atmosphere every week for this simple cost effective medium. When used in a very targeted manner, online advertising may be cost effective and carbon efficient. Print advertising also requires thought about targeting and being transparent about the emissions caused by the marketing process.

Typically, any service supplied that helps a company inform, educate or communicate with existing or potential buyers of a company's goods and/or services can be a marketing campaign, or part thereof.

The Internet has currently grown to be a global information system supported by content supplied by millions of netizens all around the world. Content aggregators maintaining portal sites add further value to the content generated by individuals through appropriate packaging, distribution and publicity.

One of the important sources of income to any content provider/website owner and particularly the portal owner is the revenue generated by online advertisements. These advertisements in the form of ad banners and hyperlinks act as “Brand Reminders” and as gateways for bringing visitors to the advertiser's own web site.

The revenue stream generated by these ads is a reliable source of income for the website owner to reward the content contributors and to defray the cost of operation of the portal. This ad revenue may go a long way in bringing many of the Internet's community services free to the netizen population. A healthy online advertising industry will therefore benefit the consumers in the Internet industry.

In order for the online ad industry to flourish, the ad industry, the advertisers and the website owners should have a mutually rewarding relationship. One of the key aspects of such a relationship is a satisfactory payment mechanism linked to an agreed ad delivery standard.

The first and the most obvious method is the “Period-based” payment system where the advertiser pays a certain amount of money for displaying his banner/message on a web page for a certain period. The number of potential customers of the advertiser who have an opportunity to view such ads can depend on the traffic on the site and the profile of the visitors. Site traffic and visitor profiles are normally certified by the site owner based on server log records and the advertiser has no choice but to accept this information as correct.

The second method by which advertisements on the Internet are paid for is the “Click Through” method (also referred to as the CPC basis) where the payment is based on the number of times a visitor clicks through the banner or hyperlink ad message. The number of “click throughs” can be tracked by the advertiser to some extent by monitoring the activity on the page linked to the ad. This does not, however, always match the “click through” figures claimed by the site owner since some of the “click throughs” may be abandoned by the visitors before they reach the target site.

The third and the most popular method by which advertisements are paid for, is the “Per View” basis (also referred to as the CPM basis). Under this system, the website owner contracts to deliver a stated number of exposures of the advertiser's ad banner to his visitors at a given cost. A satisfactory conclusion of this contract requires a certification from the website owner of the number of visitors who have visited the web page where the ad message is displayed. The advertiser has no means of verifying the statement made by the site owner in this regard since he has no control over the server where the ad is placed.

The essence of a successful payment system is to ensure that the advertiser is fully satisfied that the contracted number of ad exposures has taken place.

Yet another challenge in the online ad delivery is that the banner ads are normally accompanied by embedded pictures or software code that may not load on some browsers. Sometimes the visitor might have switched off the option on his browser to view pictures or Java programs, for example, and thus the ad may not be shown even though the visitor may be able to view other content on the web page. In such cases, there would be a difference between the page visit statistics of the website owner and the ad view benefits derived by the advertiser.

### SUMMARY OF THE INVENTION

We are living in an era of new awareness in which people want to help to save the planet and fight climate change, yet, on other hand, people prefer to avoid any kind of advertising. However, if people have the option to view or interact with online advertising of their interest (e.g., a quality targeted ad), and this online advertising also offers them an additional environmental benefit linked to the advertising such as a carbon offset in real time (e.g., neutralizing carbon dioxide in real time), the consequence will be that the online advertising will provide the overall online advertising campaign with better performance and results because people will be more highly motivated and satisfied with clicking and interacting with the advertising.

This advertising model linked with micro emission reduction credits (micro carbon offset) may be known as “Sustainable Online Advertising”.

The invention is a method and system for dividing and trading emission reduction credits between linked websites and advertisers in order to transform any kind of online advertising model into sustainable online advertising. The invention allows for any online advertising model to become “green” because a Sustainable Ad Network's online advertising model can link their clicks, impressions or acquisitions to micro emission reduction credits in real time.

The invention is also related to a Sustainable Ad Network system, which is a collection of computers interconnected by the Internet or other communication channels. All or part of the Sustainable Ad Network can be implemented on a server or other computer. The server can include at least a processor, a volatile memory and a non-volatile memory and a data base, and be configured to receive and request the information related to the emission reduction credits in order to subscribe to a new green project. The processor can be configured to divide the emission reduction credits into micro emission reduction credits, where the emission reduction credits previously had been acquired in international carbon registry markets, and where each emission reduction credit is connected to green projects around the world that reduce or avoid greenhouse gases. The processor can create a portfolio with different percentages of emission reduction credits and validate the cost of an emission reduction portfolio in order to calculate the profit of the portfolio. The processor can send the emission reduction portfolio to a reduction credits inventory which is part of the Sustainable Ad network system. The processor can also identify the geographical/IP target for focusing the online advertising.

The Sustainable Ad network system links the micro emission reduction credits to any kind of online advertisement in remote servers or computers, so that every time a user clicks, view or interacts with the advertisement, the Sustainable Ad network system automatically subtracts a micro emission reduction credit from the credits inventory and adds, e.g., credits, the micro emission reduction credit to a website emission reduction credit account, advertiser emission reduction credit account or personal emission reduction credit account. The Sustainable Ad network system can send an alarm via e-mail, tweet, SMS or other communication media if the credits inventory falls below a minimum threshold of micro emission reduction credits so that new emission reduction credits can be purchased.

### BRIEF DESCRIPTION OF THE DRAWINGS

FIG. 1 illustrates a general emission reduction credits inventory and process that divides the emission reduction credits into smaller parts (micro emission reduction credits) in order to be accredited in linked website emission reduction credit accounts, according to the invention.

FIG. 2 illustrates the general emission reduction credits inventory and process that divides the emission reduction credits into smaller parts (micro emission reduction credits) in order to be accredited in linked advertiser emission reduction credit accounts, according to the invention.

FIG. 3 illustrates the general emission reduction credits inventory and process that divides the emission reduction credits into smaller parts (micro emission reduction credits) in order to be accredited in linked personal emission reduction credit accounts, according to the invention.

FIG. 4 illustrates the characteristics of the general emission reduction credit inventory, according to the invention.

FIG. 5 illustrates the characteristics of the general emission reduction credit inventory, such as sustainable advertising targeting services, and the portion of the money paid to the publisher website from the Sustainable Ad Network that is invested to pay for the micro emission reduction credits when the service is linked to the website emission reduction credit account, according to the invention.

FIG. 6 illustrates the characteristics of the general emission reduction credit inventory, such as sustainable advertising targeting services, and the portion of the money paid by the advertiser to the Sustainable Ad Network that is invested to pay for the micro emission reduction credits when the service is linked to the advertiser emission reduction credit account, according to the invention.

FIG. 7 illustrates the characteristics of the general emission reduction credit inventory, such as the sustainable advertising targeting services, and the portion of the money paid by the advertiser to the Sustainable Ad Network that is invested to pay for the micro emission reduction credits when the service is linked to the personal emission reduction credit account, according to the invention.

FIG. 8 illustrates the “Sustainable logo” on the advertisements which can display to the user a message window or element with information about the amount of the micro emission reduction credits linked to this advertisement in real time, according to the invention.

FIG. 9 illustrates the “Sustainable logo” on websites linked to the Sustainable Ad Network in order to promote the website emission reduction credit account, according to the invention.

FIG. 10 illustrates the “Top Banner” on the advertisers' promotional websites which informs users that they previously clicked on a sustainable advertising and shows the total amount of micro emission reduction credits that this online sustainable advertising campaign has accumulated up to the present date in real time, according to the invention.

FIG. 11 illustrates further details of the website emission reduction credit account linked to the Sustainable Ad Network platform as well as the online advertisement section of the website linked to both, according to the invention.

FIG. 12 illustrates the advertiser emission reduction credit account linked to the Sustainable Ad Network platform, and the online advertisement section of the website linked to the Sustainable Ad Network platform, according to the invention.

FIG. 13 illustrates the personal emission reduction credit account linked to the Sustainable Ad Network platform, and the online advertisement section of the personal emission reduction credit accounts linked to the Sustainable Ad Network platform, according to the invention.

FIG. 14 illustrates the subscription process of new green project emission reduction credits to the general emission reduction credits inventory, according to the invention.

FIG. 15 illustrates the Sustainable Ad Network's general emission reduction credits inventory process linked to a third party emission reduction credit account, according to the invention.

FIG. 16 illustrates the Portfolios system of the general emission reduction credits inventory, according to the invention.

FIG. 17 illustrates the process of targeting the Portfolios of emission reduction credits in function of the geographical/IP target of the advertisement, according to the invention.

FIG. 18 illustrates the Sustainable Ad network system according to the invention.

### GLOSSARY OF TERMS

Greenhouse gases: Greenhouse gases are gases found in the Earth's atmosphere that absorb and emit radiation within the thermal infrared range. This process is the fundamental cause of the greenhouse effect. The primary greenhouse gases in the Earth's atmosphere are carbon dioxide, methane, nitrous oxide, water vapor and ozone.

Carbon dioxide: Carbon dioxide (chemical formula CO2) is a naturally occurring chemical compound composed of two oxygen atoms covalently bonded to a single carbon atom.

Carbon offset: Carbon offset is a reduction in emissions of carbon dioxide or greenhouse gases made in order to compensate for or to offset an emission made elsewhere. Carbon offsets are measured in metric tons of carbon dioxide=equivalent (CO2e) and may represent six primary categories of greenhouse gases. The categories include: carbon dioxide (CO2), methane (CH4), nitrous oxide (N2O), perfluorocarbons (PFCs), hydrofluorocarbons (HFCs), and sulfur hexafluoride (SF6). One carbon offset represents the reduction of one metric ton of carbon dioxide or its equivalent (tCO2e) in other greenhouse gases.

tCO2e: Represents one metric ton of carbon dioxide or its equivalent in other greenhouse gases such as methane (CH4), nitrous oxide (N2O), perfluorocarbons (PFCs), hydrofluorocarbons (HFCs), and sulfur hexafluoride (SF6).

Carbon credit: A carbon credit is a generic term for any tradable certificate or permit representing the right to emit one ton of carbon dioxide or the mass of another greenhouse gas with a carbon dioxide equivalent (tCO2e) equivalent to one ton of carbon dioxide.

Carbon credits and carbon markets are a component of national and international attempts to mitigate the growth in concentrations of greenhouse gases (GHGs). One carbon credit is equal to one metric ton of carbon dioxide, or in some markets, carbon dioxide equivalent gases.

Carbon emissions trading: Carbon emissions trading is an application of an emissions trading approach. Carbon emissions trading is a form of emissions trading that specifically targets carbon dioxide (calculated in tons of carbon dioxide or its equivalent (tCO2e)) and currently constitutes the bulk of emissions trading. This form of permit trading is a common method countries utilize in order to meet their obligations specified by the Kyoto Protocol, namely the reduction of carbon emissions in an attempt to reduce and/or mitigate future climate change.

Offsetting emissions: Offsetting emissions compensates for certain amounts of greenhouse gases with the acquisition of carbon offsets.

Carbon neutral: Carbon neutrality, or having a net zero carbon footprint, refers to achieving net zero carbon emissions by balancing a measured amount of carbon released with an equivalent amount captured or offset, or by buying enough carbon credits to make up the difference. It is used in the context of carbon dioxide releasing processes, associated with transportation, energy production and industrial processes.

The carbon neutral concept may be extended to include other greenhouse gases (GHG) measured in terms of their carbon dioxide equivalence—the impact a GHG has on the atmosphere expressed in the equivalent amount of CO2.

Emission reduction credits: An emission reduction credit is equal to one unit of carbon offset calculated in tons of carbon dioxide or its equivalent (tCO2e).

Micro carbon offset: Micro carbon offset is the action of dividing carbon offsets or emission reduction credits from tons (tCO2e) into smaller parts such as pounds (Lb), kilograms (Kg), etc.

Micro emission reduction credits: Micro emission reduction credits are the result of dividing emission reduction credits or carbon offsets from tons (tCO2e) into smaller parts such as pounds (Lb), Kilograms (Kg), etc.

Click: A click is the action of a computer user moving a cursor to a certain location on a screen (pointing) and then pressing a mouse button, usually the left button (clicking), such as by using a mouse or other pointing device. An example of a click is selecting an online advertisement.

Impression: An impression is when an online advertisement is loaded in a visible area of a user's or viewer's browser window on an in-focus website for at least one second.

Acquisition: An acquisition is the action of buying, purchasing, and acquiring any product or service.

CPC: Cost per click (CPC) is an Internet advertising model used to direct traffic to websites, where advertisers pay the publisher (typically a website owner) when the ad is clicked.

CPM: Cost per millard (CPM), also called cost per thousand (CPT) (in Latin mile means thousand), is a commonly-used measurement in online advertising where advertisers pay the publisher (typically a website owner) on the basis of what it costs to show the ad to one thousand viewers or impressions on the websites. It is used in marketing as a benchmark to calculate the relative cost of an advertising campaign or an ad message in a given medium. Rather than an absolute cost, CPM estimates the cost per 1000 views or impressions of the ad.

CPA: Cost per acquisition (CPA) is a method of advertising whereby the advertiser only pays when an advertisement delivers an acquisition. Moreover, CPA is very effective for an advertiser to pay because they only pay when the advertising has met its purpose. The publisher website relies on the conversion rate of the advertiser's website, something which the publisher cannot control.

URL: In computing, a Uniform Resource Locator or Universal Resource Locator (URL) is a specific character string that constitutes a reference to an Internet resource, or website.

Online advertising: Online advertising is a form of promotion that uses the Internet and World Wide Web to deliver marketing messages to attract customers. Examples of online advertising include contextual ads on search engine results pages and publishers websites, banner ads, Rich Media Ads, Video Ads, Social network advertising, online classified advertising, advertising networks and e-mail marketing, including e-mail spam. Many of these types of ads are delivered by an Ad Network.

Sustainable Online Advertising: Any online advertising model that becomes “green” because each click, impression (view) or acquisition is linked to micro emission reduction credits in real time. This means that every time a person clicks or views an online advertisement, an amount of micro emission reduction credits is subtracted from the general emission reduction credits inventory and added, e.g., credited, to a third party emission reduction credit account.

Website: A collection of related web pages containing images, videos or other digital assets. A website is hosted on at least one web server, accessible via a network such as the Internet or a private local area network through an Internet address known as a Uniform Resource Locator (URL).

Advertiser: A person, organization or company that places online advertisements in order to target customers.

Surfer: A person who navigates the Internet and also interacts with websites and advertisements.

User: A person who navigates the Internet and also interacts with websites and advertisements.

Ad Network: A platform that connects advertisers to websites that want to host advertisements. The key function of an ad network is aggregation of ad space supply from publishers and matching it with advertiser demand. The ad network value is the aggregation of publisher (website) ad space and selling to advertisers the online ad space in order to display the correct advertisement to the targeted persons.

Sustainable Ad Network: An Ad Network that displays online advertisement linked to micro carbon reduction credits (micro carbon offsets) in real time.

General emission reduction credits inventory: The repository composed of at least one emission reduction credit project. The Sustainable Ad Network can divide the emission reduction credits of the general emission reduction credits inventory into smaller parts (called micro emission reduction credits) and link them to any kind of online advertisement. Therefore, every time a user clicks or views a Sustainable Ad Network advertisement, micro emission reduction credits are subtracted from the general emission reduction credits inventory and added, e.g., credited, to a third party emission reduction credit account.

Emission reduction credit account: The repository where all the micro-emission reduction credits are added, e.g., credited, from the general emission reduction credits inventory that were previously subtracted. An emission reduction credit account, for example, can include a website emission reduction credit account, an advertiser emission reduction credit account, or a personal emission reduction credit account.

Platform: The software and framework technology on which the applications of the general emission reduction credits inventory, emission reduction credit account and micro carbon offsets transit (subtracted and added) may be executed.

Computing: The activity of using and improving computer hardware (personal computer, laptops, tablets, smartphones, and devices with processors) and software.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

General Characteristics of the Sustainable Ad Network System

The invention allows for any online advertising model to become “green” because a Sustainable Ad Network's online advertising model can link their clicks or impressions to micro emission reduction credits.

This means that because of the invention, any banner, video, audio and/or text advertisement displayed on any website can offset carbon dioxide and other greenhouse gas emissions in real time with every click, impression or acquisition, in order to combat climate change.

The Sustainable Ad Network can create unique emission reduction credit accounts (with unique URLs) for any website, advertiser or person that wishes to help the planet through the clicks, impressions or acquisitions, of different sustainable online advertising campaigns.

The General Emission Reduction Credits Inventory and Division of the Emission Reduction Credits into Smaller Parts (Micro Emission Reduction Credits) for Accreditation in Third Party Emission Reduction Carbon Accounts

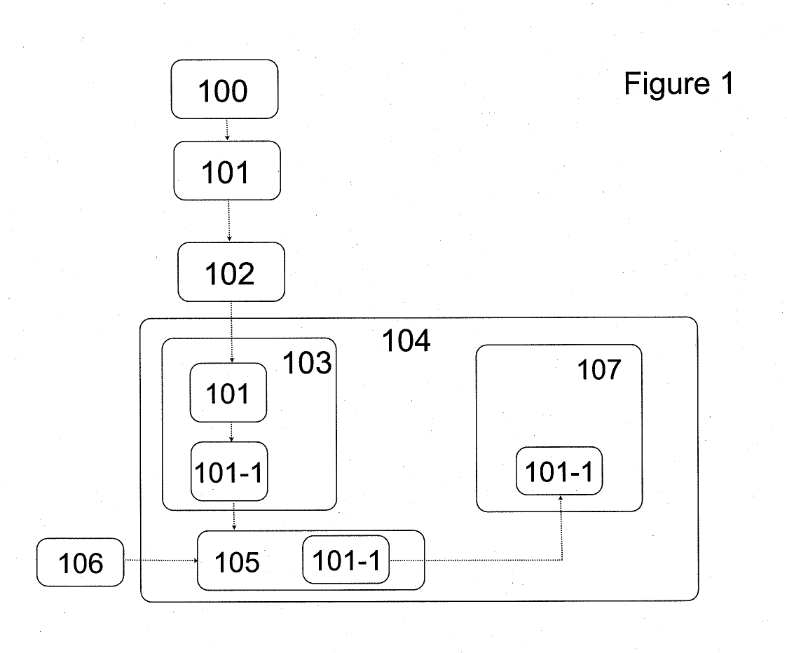

In one embodiment, the Sustainable Ad Network (104) system shown in FIG. 1 acquires emission reduction credits (101) in international carbon registries markets (102) connected to green projects (100) around the world that reduce or avoid greenhouse gases. Subsequently, these emission reduction credits (101) are subscribed or accredited to the general emission reduction credits inventory (103) of the Sustainable Ad Network (104), which can include a computer network. The Sustainable Ad Network (104) can include software that can be executed in a processor for dividing the emission reduction credits (101) into smaller parts called micro emission reduction credits (101-1) and link them to any kind of online advertisement (105). The micro emission reduction credits (101-1) may be divided equally or unequally from the emission reduction credits (101). The general emission reduction credits inventory may be stored in a database.

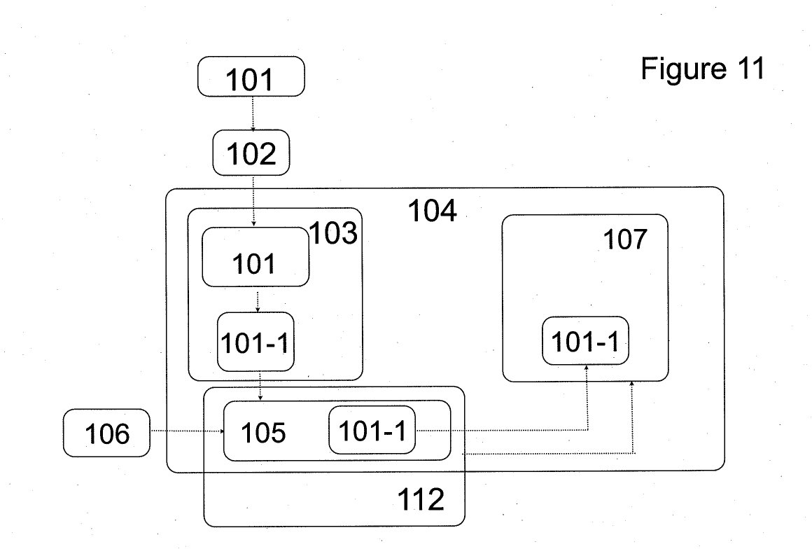

Therefore, as shown in FIG. 1, every time a person clicks, views or interacts (e.g., an online acquisition such as a purchase) (106) with a Sustainable Ad Network (104) advertisement (105), micro emission reduction credits (101-1) are subtracted from the Sustainable Ad Network's (104) general emission reduction credits inventory (103) and added, e.g., credited, to the publishing website's emission reduction credit account (107) in the case where the Sustainable Ad Network (104) service is linked to a website emission reduction credit account (107). The website emission reduction credit account may be stored in the database and is described further below with respect to FIG. 11.

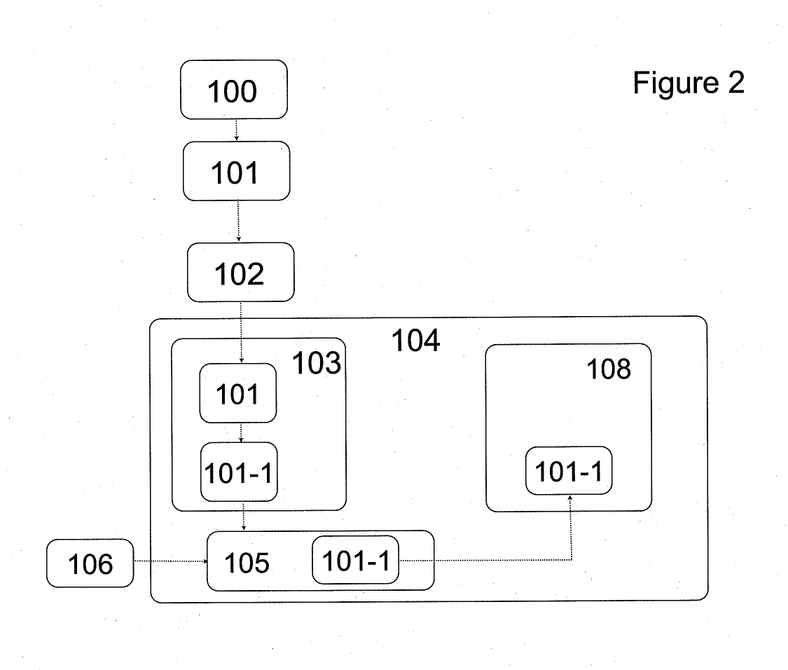

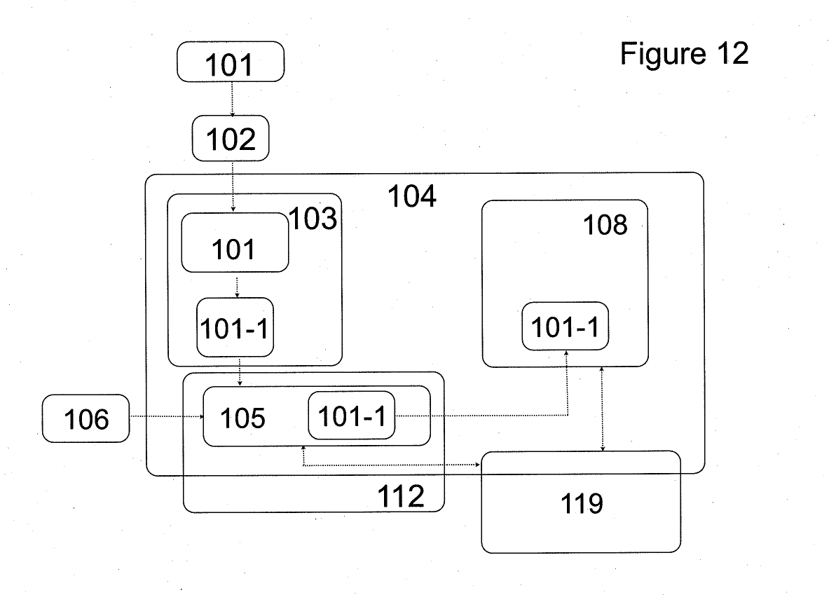

In another embodiment, as shown in FIG. 2, every time a person clicks, views or interacts (106) with a Sustainable Ad Network (104) advertisement (105), micro emission reduction credits (101-1) are subtracted from the Sustainable Ad Network's (104) general emission reduction credits inventory (103) and added, e.g., credited, to the advertiser emission reduction credit account (108) in the case where the Sustainable Ad Network (104) service is linked to an advertiser emission reduction credit account (108). The advertiser emission reduction credit account may be stored in the database and is described further below with respect to FIG. 12.

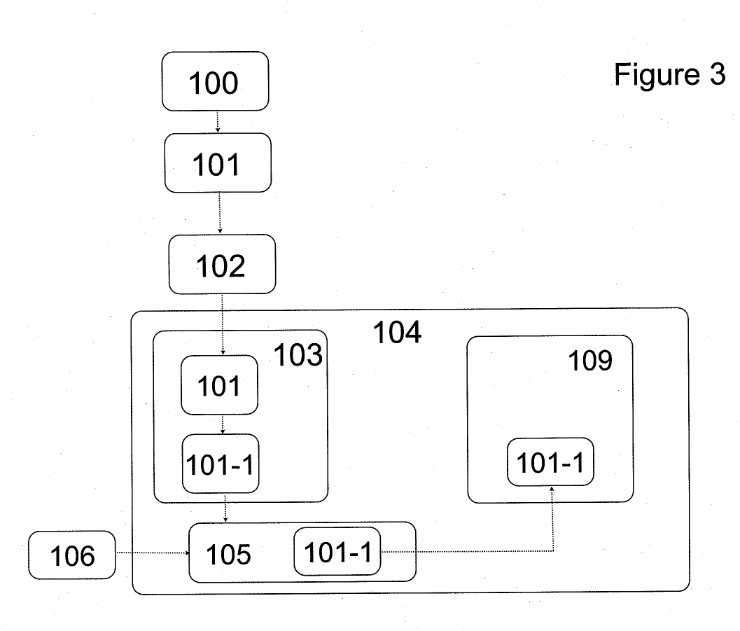

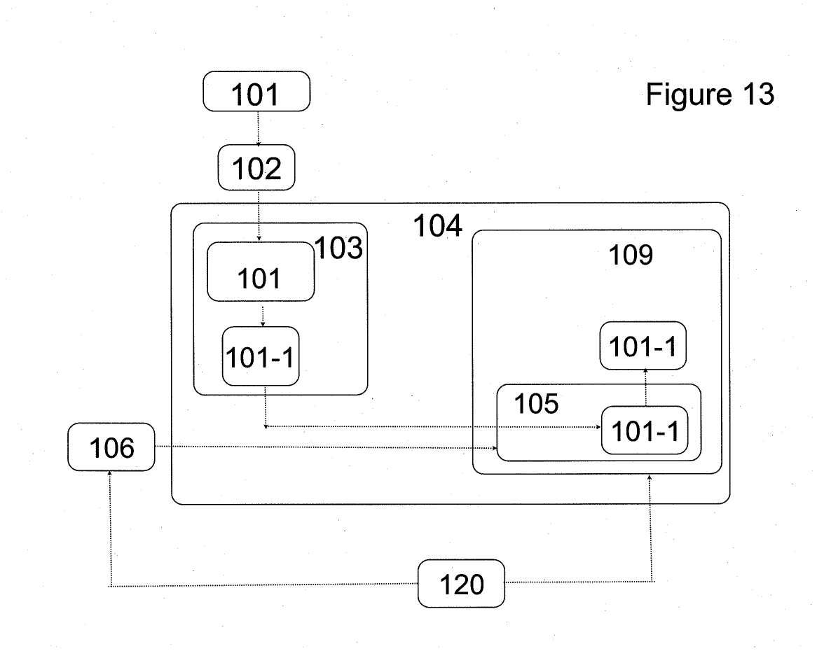

In yet another embodiment, as shown in FIG. 3, every time a person clicks, views or interacts (106) with a Sustainable Ad Network (104) advertisement (105), micro emission reduction credits (101-1) are subtracted from the Sustainable Ad Network's (104) general emission reduction credits inventory (103) and added, e.g., credited, to the personal emission reduction credit account (109) in the case where the Sustainable Ad Network (104) service is linked to a personal emission reduction credit account (109) of the user. The personal emission reduction credit account may be stored in the database and is described further below with respect to FIG. 13.

One objective of the invention is to avoid double counting of micro emission reduction credits (101-1) and to guarantee transparency during the process of the transfer (e.g., the subtraction and addition) of micro emission reduction credits (101-1) from the general emission reduction credits inventory (103) to the website emission reduction credit account (107), as in FIG. 1, to the advertiser emission reduction credit account (108), as in FIG. 2, or to the personal emission reduction credit account (109), as in FIG. 3.

Characteristics of the General Emission Reduction Credit Inventory

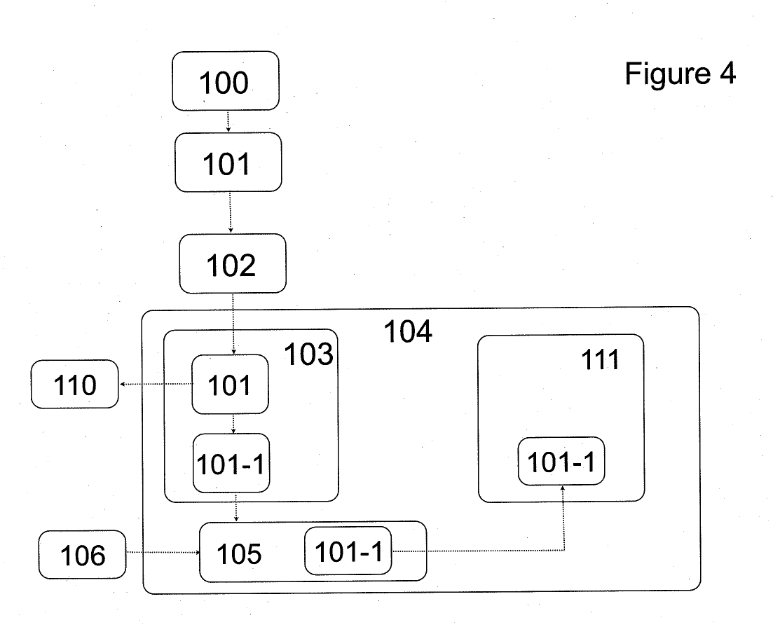

As shown in FIG. 4, when the Sustainable Ad Network's (104) general emission reduction credit inventory (103) falls below a minimum threshold of micro emission reduction credits (101-1), the Sustainable Ad Network system automatically sends an notification alarm or message (110) via e-mail, tweet, SMS, or other communication media to notify Sustainable Ad Network employees so that new emission reduction credits (101) can be purchased in the international carbon registries markets (102). These new emission reduction credits (101) can be subscribed to the general emission reduction credit inventory (103) of Sustainable Ad Network (104) so the process of crediting them to the appropriate emission reduction credit account (111) can be performed without interruption. In another embodiment, when the general emission reduction credit inventory (103) falls below the minimum threshold of micro emission reduction credits (101-1), the Sustainable Ad Network (104) system automatically purchases new emission reduction credits (101) from the international carbon registries markets (102).

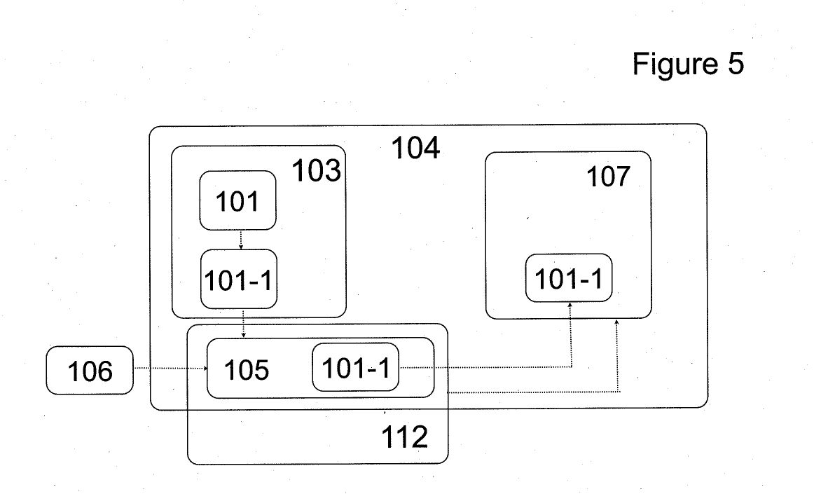

In an embodiment, the Sustainable Ad Network (104) targets the advertisers' intended audience by placing the appropriate online advertising (105) like banners, videos and text ads on the appropriate websites (112), as illustrated in FIG. 5. The appropriate websites (112) may include targeting based on geographical area, IP address, etc. In addition, every time a person clicks, views or interacts (e.g., an online acquisition such as a purchase) (106) with or through a sustainable advertisement (105) placed by the Sustainable Ad Network (104), a portion of the money paid to the publisher website (112) from the Sustainable Ad Network (104) is invested to pay for the micro emission reduction credits (101-1) when the service is linked to the website emission reduction credit account (107).

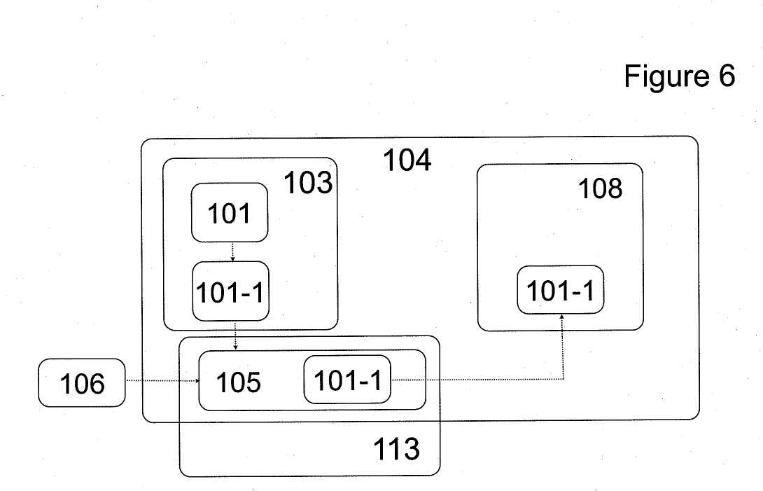

In the embodiment shown in FIG. 6, every time a person clicks, views or interacts (106) with or through a sustainable advertisement (105) placed by the Sustainable Ad Network (104), a portion of the money paid by the advertiser (113) to the Sustainable Ad Network (104) is invested to pay for the micro emission reduction credits (101-1) when the service is linked to the advertiser emission reduction credit account (108).

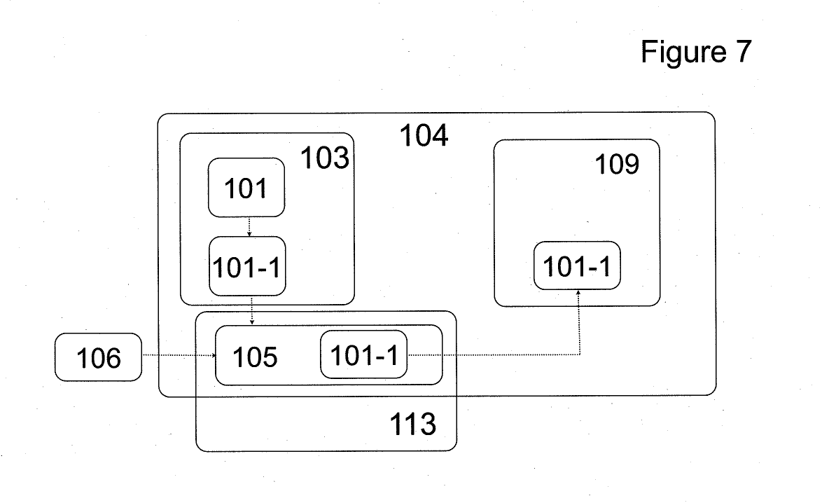

In the embodiment shown in FIG. 7, every time a person clicks, views or interacts (106) with or through a sustainable advertisement (105) placed by the Sustainable Ad Network (104), a portion of the money paid by the advertiser (113) to the Sustainable Ad Network (104) is invested to pay for the micro emission reduction credits (101-1) when the service is linked to the personal emission reduction credit account (109).

The “Sustainable Logo” on Advertisements

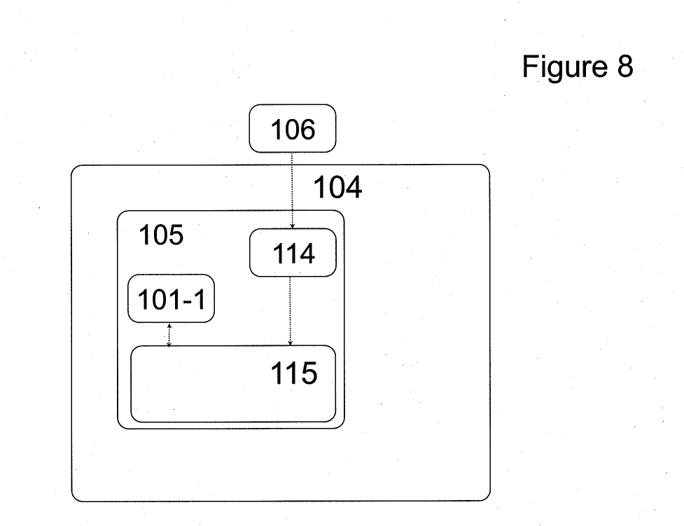

As shown in FIG. 8, the Sustainable Ad Network's (104) technology can display a “Sustainable logo” (114) on an advertisement (105). When the user moves the mouse over, views, or clicks (106) on the “Sustainable logo” (114), a message window or element (115) is displayed with information about the amount of the micro emission reduction credits (101-1) linked to the advertisement (105) in real time. The “Sustainable logo” (114) may include graphics, text, audio, and/or video. The message window or element (115) may also include other information about the climate benefits of this particular advertisement (105), including the amount of carbon dioxide equivalent that the particular banner, video or text ad is neutralizing in real time per each click, view or interaction (106) with the advertisement (105). The message window or element (115) may be part of the advertisement (105) or a separate pop-up window, for example.

The “Sustainable Logo” on Websites

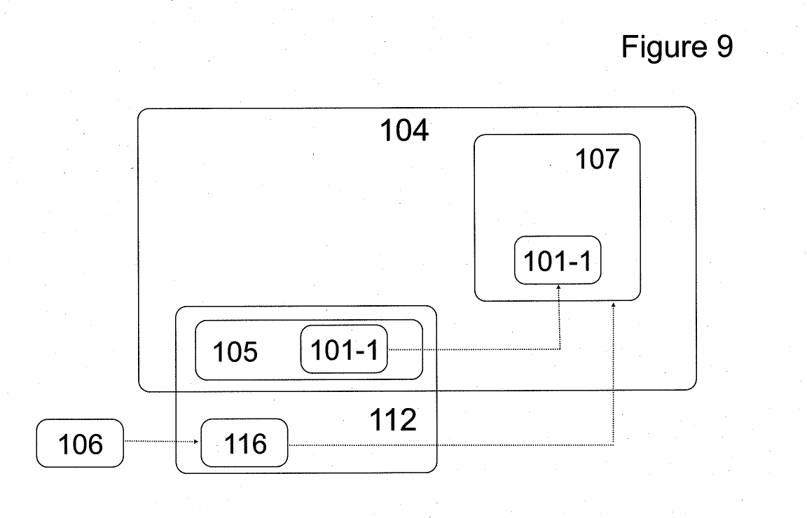

As shown in FIG. 9, the Sustainable Ad Network's (104) technology is linked to a website (112) that displays a sustainable advertisement (105), and likewise this linked website (112) is linked to a website emission reduction credit account (107). The Sustainable Ad Network's (104) technology displays a “Sustainable Website logo” (116) on the linked website (112). When the user clicks (106) on the “Sustainable Website logo” (116), the user will then be shown the website emission reduction credit account (107) linked with a URL and be shown the amount of micro emission reduction credits (101-1) that the website has accumulated up to the present date in real time and other information. The “Sustainable Website logo” (116) may include graphics, text, audio, and/or video. In one embodiment, the website emission reduction credit account (107) linked with the URL may be shown as a separate pop-up window or as part of the advertisement (105), for example.

The “Top Banner” on the Advertisers' Promotional Websites

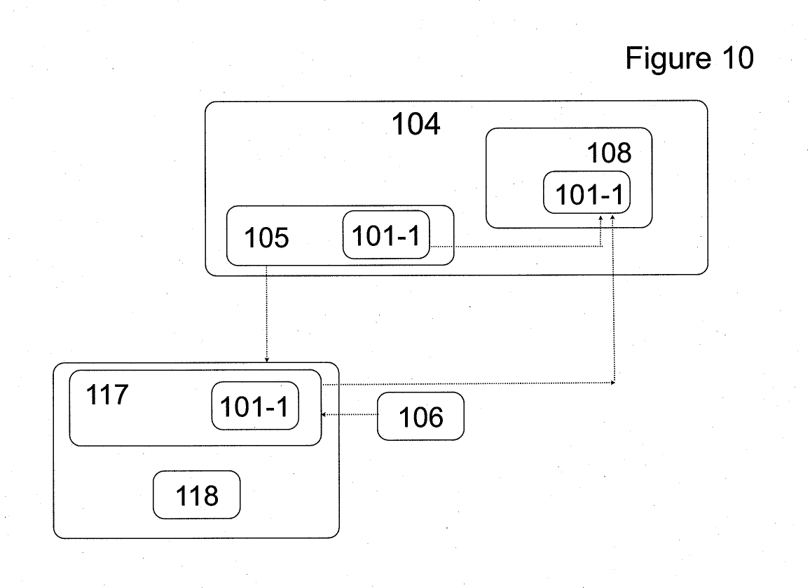

As shown in FIG. 10, the Sustainable Ad Network's (104) technology displays a top banner (117) on the promotional landing page (118) of the advertiser that is linked with a URL to the online sustainable advertising (105). The top banner (117) may also be displayed on a linked website. This top banner (117) informs users that they previously clicked (106) on a sustainable advertisement (105), and shows the total amount of micro emission reduction credits (101-1) that this online sustainable advertising (105) campaign has accumulated up to today in real time, as well as other information such as the amount of micro emission reduction credits (101-1) that has been accredited with the user's click (106). Also, users can see on this top banner (117) the climate benefit of the online sustainable advertising (105) campaign, as well as the details of the carbon offset green projects. The user can click (106) on the top banner to be shown the advertiser emission reduction credit account (108) and see all the details of the amount of micro emission reduction credits (101-1) that has been accredited up to the present date in real time and the details of the green projects of the micro emission reduction credits (101-1). The top banner (117) may include graphics, text, audio, and/or video.

Further Details of the Website Emission Reduction Credit Account

As shown in FIG. 11, the website emission reduction credit account may be linked to the Sustainable Ad Network platform or system and to the online advertisements on a website. A general emission reduction credit inventory (103) is created with at least one emission reduction credit (101) in a Sustainable Ad Network (104) platform, where that emission reduction credit (101) was previously purchased in an international carbon registries market (102). The emission reduction credits (101) of the general emission reduction credit inventory (103) can be divided into micro emission reduction credits (101-1). The micro emission reduction credits (101-1) may be divided equally or unequally from the emission reduction credits (101).

At least one website (112) can be linked to the Sustainable Ad Network (104) platform. A unique website emission reduction credit account (107) with unique URLs can then be created for each linked website (112). At least one sustainable advertisement (105) can be associated to each linked website (112), and the sustainable advertisements (105) can be placed on each linked website (112). The general emission reduction credit inventory (103) and the website emission reduction credit account (107) may be stored in a database.

When a user clicks, views or interacts (e.g., an online acquisition such as a purchase) (106) with a sustainable advertisement (105) placed in each linked website (112), a micro emission reduction credit (101-1) can be subtracted from the general emission reduction credits inventory (103), and added, e.g., credited, to the emission reduction credit account (107) of the website (112) where said sustainable advertisement (105) has been viewed, clicked or interacted with (106).

Further Details of the Advertiser Emission Reduction Credit Account

As shown in FIG. 12, the advertiser emission reduction credit account may be linked to the Sustainable Ad Network platform or system and to the online advertisement section of a website. A general emission reduction credit inventory (103) is associated with at least one emission reduction credit (101) in a Sustainable Ad Network (104) platform, where that emission reduction credit (101) was previously purchased in an international carbon registries market (102). The emission reduction credits (101) of the inventory (103) can be divided into micro emission reduction credits (101-1). The micro emission reduction credits (101-1) may be divided equally or unequally from the emission reduction credits (101).

At least one website (112) can be linked to the Sustainable Ad Network (104) platform. A unique advertiser emission reduction credit account (108) (with unique URLs) for each advertiser (119) is associated. At least one sustainable advertisement (105) can be associated to each linked website (112), and the sustainable advertisement (105) can be placed on each said linked website (112). The general emission reduction credit inventory (103) and the advertiser emission reduction credit account (108) may be stored in a database.

When a user clicks, views or interacts (e.g., online acquisition like a purchase) (106) with a sustainable advertisement (105) placed in each linked website (112), a micro emission reduction credit (101-1) can be subtracted from the general emission reduction credits inventory (103), and added, e.g., credited, to the emission reduction credit account (108) of the advertiser (119) who is paying for that sustainable advertisement (105) that has been clicked, viewed or interacted with (106).

Further Details of the Personal Emission Reduction Credit Account

As shown in FIG. 13, the personal emission reduction credit account may be linked to the Sustainable Ad Network platform or system and to the online advertisement section of a website. A general emission reduction credit inventory (103) with at least one emission reduction credit (101) in a Sustainable Ad Network (104) platform is associated, where that emission reduction credit (101) was previously purchased in an international carbon registries markets (102). The emission reduction credits (101) of the inventory (103) can be divided into micro emission reduction credits (101-1). The micro emission reduction credits (101-1) may be divided equally or unequally from the emission reduction credits (101).

At least one unique personal emission reduction account (109) for each user (120) can be linked to the Sustainable Ad Network (104) platform, and a unique personal emission reduction account (109) (with unique URLs) for each user (120) can be associated. At least one sustainable advertisement (105) can be associated to each linked unique personal emission reduction account (109). A sustainable advertisement (105) can be placed on each said linked unique personal emission reduction account (109). The general emission reduction credit inventory (103) and the personal emission reduction credit account (109) may be stored in a database.

When it is determined that that a person clicks, views or interacts (e.g., an online acquisition such as a purchase) (106) a sustainable advertisement (105) placed in each linked unique personal emission reduction account (109), a micro emission reduction credit (101-1) can be subtracted from the general emission reduction credits inventory (103), and added, e.g., credited, to the linked unique personal emission reduction account (109) of the user (120) that clicked, viewed or interacted (106) with the sustainable advertisement (105).

Subscribing a New Green Project Emission Reduction Credits to the General Emission Reduction Credits Inventory

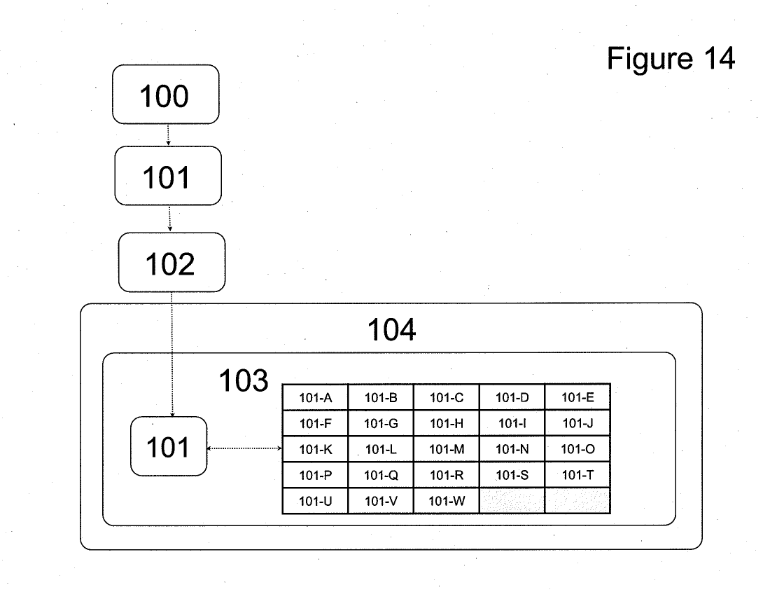

As shown in FIG. 14, new green project emission reduction credits can be subscribed to the general emission reduction credits inventory. In particular, after the purchase (e.g., acquisition) of the emission reduction credits (101) in international carbon registry markets (102) connected to green projects (100) around the world that reduce or avoid greenhouse gases, these emission reduction credits (101) can be subscribed or accredited to the general emission reduction credits inventory (103) of the Sustainable Ad Network (104). The emission reduction credits (101) may be purchased manually or automatically.

The processor can request certain information in order to subscribe the new green project (100) emission reduction credits (101) in the general emission reduction credits inventory (103). The information may assist in tracking the credits (101), auditing the credits (101) and in creating statistical information that can be shown to users. Such information may include:
a) (101-A): Name of the green project (100) emission reduction credits (101).
b) (101-B): ID of the green project (100) emission reduction credits (101).
c) (101-C): Purchase Date.
d) (101-D): Person responsible for purchase.
e) (101-E): Amount (tons) purchased of the emission reduction credits (101).
f) (101-F): Total investment purchase on these emission reduction credits (101).
g) (101-G): Cost per ton of this emission reduction credit (101) of this green project (100).
h) (101-H): Sales price per ton of this emission reduction credit (101) of this green project (100).
i) (101-I): Provider.
j) (101-J): Vintage Date.
k) (101-K): Standard.
l) (101-L): Carbon Registry.
m) (101-M): Verifier.
n) (101-N): Green Project Type.
o) (101-O): Description.
p) (101-P): Country.
q) (101-P): State.
r) (101-R): GPS (Global Positioning System) Longitude and Latitude.
s) (101-S): Copy of the agreement of the purchase of this emission reduction credit (101) of this green project (100).
t) (101-T): Pictures of the green project (100) that generates the emission reduction credits (101).
u) (101-U): Video of the green project (100) that generates the emission reduction credits (101).
v) (101-V): Acceptance and subscription of this new green project (100) emission reduction credits (101) into the general emission reduction credits inventory (103).
w) (101-W): Any additional information related to the green project (100).

Linking the Sustainable Ad Network's General Emission Reduction Credits Inventory to a Third Party Emission Reduction Credit Account

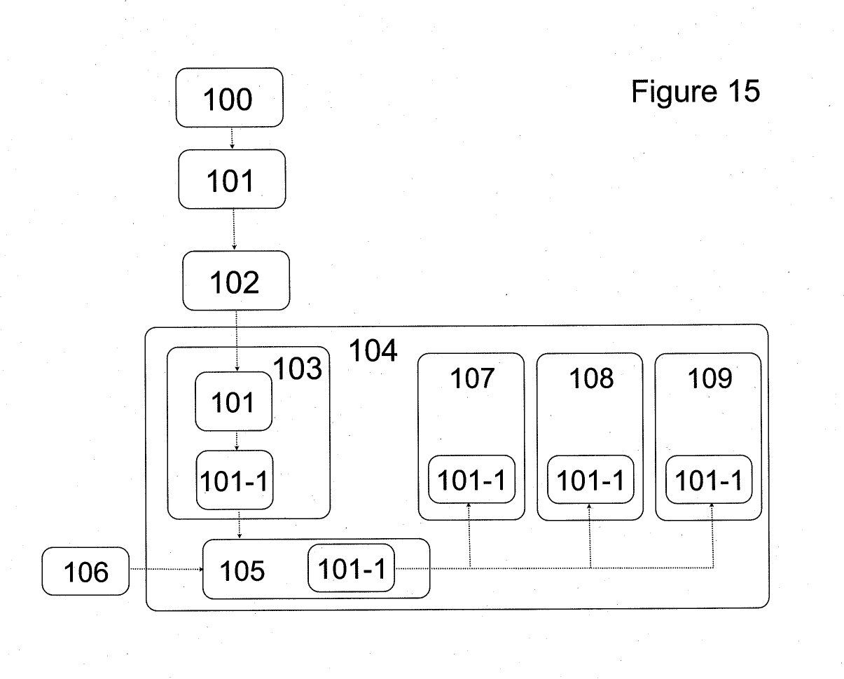

The general emission reduction credits inventory (103) may be linked to a third party emission reduction credit account, as shown in FIG. 15. The general emission reduction credits inventory (103) is composed of at least one emission reduction credit (101) of one green project (100), where that emission reduction credit (101) was previously purchased in an international carbon registries markets (102). The emission reduction credits (101) of the general emission reduction credits inventory (103) can be divided into smaller parts, called micro emission reduction credits (101-1), and linked to any kind of online advertisement (105). The micro emission reduction credits (101-1) may be divided equally or unequally from the emission reduction credits (101).

Therefore, every time a user clicks, views or interacts (e.g., an online acquisition such as a purchase) (106) with a Sustainable Ad Network (104) advertisement (105), micro emission reduction credits (101-1) are subtracted from Sustainable Ad Network's (104) general emission reduction credits inventory (103) and added, e.g., credited, to a third party emission reduction credit account, such as a website emission reduction credit account (107), as in FIG. 1, an advertiser emission reduction credit account (108), as in FIG. 2, or a personal emission reduction credit account (109), as in FIG. 3. The general emission reduction credit inventory (103) and the third party emission reduction credit account may be stored in a database.

The Portfolio System of the General Emission Reduction Credits Inventory

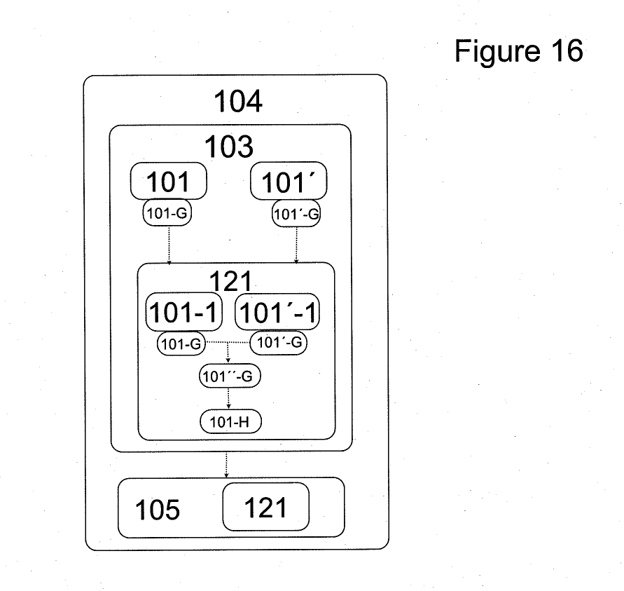

As shown in FIG. 16, when the general emission reduction credits inventory (103) is composed by at least two different emission reduction credits (101 and 101′) of al least two different green projects (100 and 100′), the Sustainable Ad Network (104) can create one or more Portfolios (121), where each Portfolio is created with different percentages of emission reduction credits (101 and 101′). The percentages may be equal or unequal in a Portfolio (121).

To create a new emission reduction credits Portfolio (121), the cost (101-G and 101′-G) of each ton of each emission reduction credits (101 and 101′) that is subscribed can be validated, and then the cost (101″-G) of the new Portfolio (121) can be calculated in conjunction with the percentage of each emission reduction credits (101 and 101′) that has been subscribed. The percentage of each emission reduction credits (101 and 101′) can be modified to satisfy contractual obligations, geographical restrictions, etc.

Afterwards, the cost (101″-G) of the new emission reduction credits Portfolio (121) can be validated and the sales price (101-H) of this Portfolio (121) can be requested in order to calculate the profit of this Portfolio (121). At the end of the process, each new emission reduction credits Portfolio (121) is part of the general emission reduction credits inventory (103) and is ready to be linked to any online advertisement campaign (105).

Targeting the Portfolios of Emission Reduction Credits in Conjunction with the Geographical/IP Target of the Advertisement

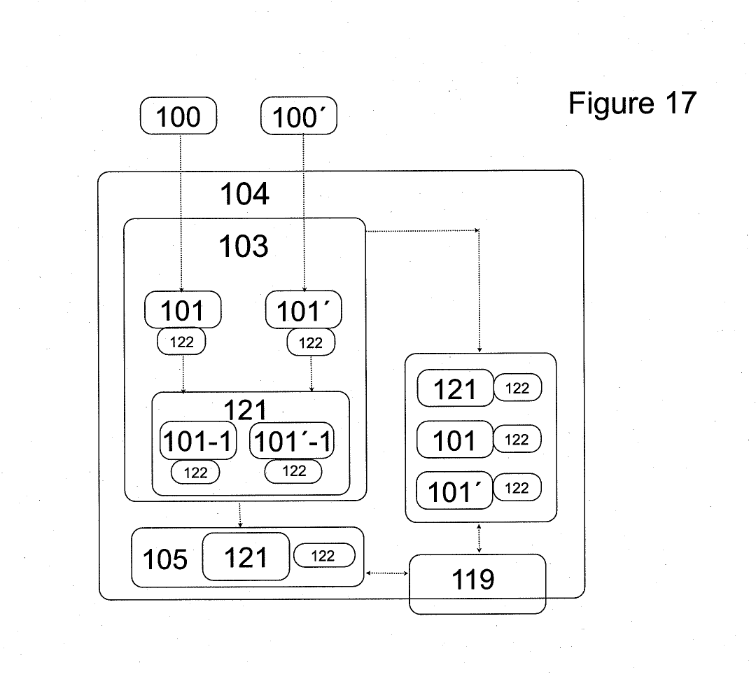

As shown in FIG. 17, the Sustainable Ad Network (104) identifies the geographical or Internet Protocol (IP) target (122) that each online advertisement (105) is linked with. The system (104) may also target (122) the online advertisement (105) based on other factors, such as personal details, stored cookie information, etc. The advertiser (119) may be offered different options of green projects (100) of emission reduction credits (101) or different emission reduction credits Portfolios (121) that are geographically closer to the target (122) online advertising (105) campaign that the advertiser (119) wishes to run. The advertiser (105) can choose the emission reduction credits (101) of their preference, or the emission reduction credits Portfolios (121) of their preference. Afterwards, the Sustainable Ad Network (104) links the correct micro emission reduction credits (101-1, 101′-1 or 121) to the correct online advertisement (105) campaign that the advertiser (119) wishes to run.

The Sustainable Ad Network System

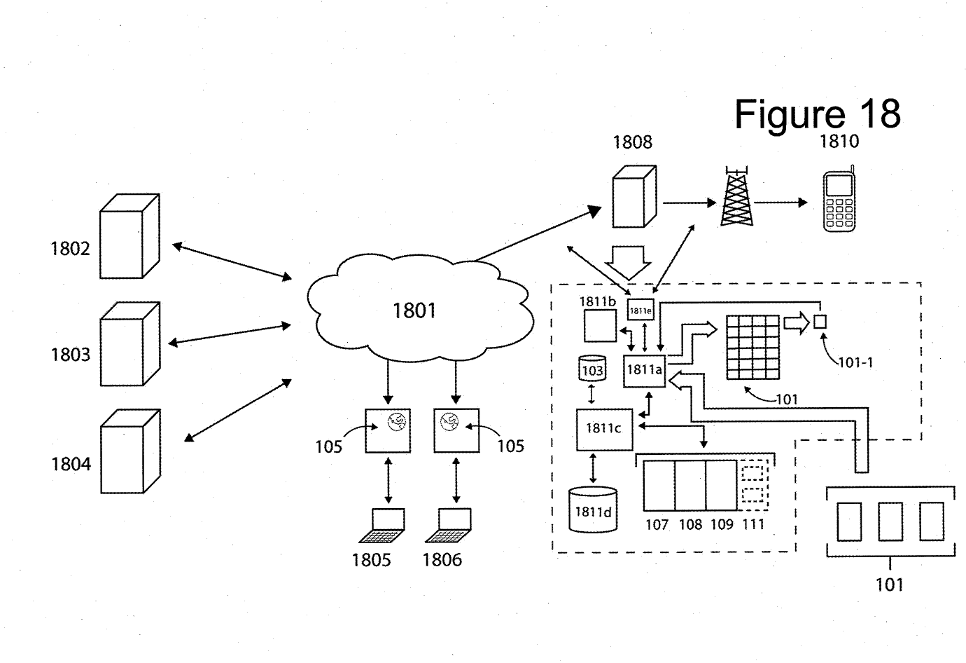

FIG. 18 shows a Sustainable Ad network system (104). The system (104) can be a collection of computers wired or wirelessly interconnected by the Internet (1801), a wide area network (WAN), a local area network, or other communication channels. Embodiments of the invention can be implemented in the Sustainable Ad network system (104). All or part of the Sustainable Ad network can be implemented in a computing device housing executable software used to facilitate the Sustainable Ad network system (104). One or more instances of the computing device may be utilized to implement any, some, or all of the components in the system (104), such as a server (1808), remote servers (1802, 1803, 1804), computers (1805, 1806), smartphones (1810), etc. The computing device includes a memory element. The memory element may include a computer readable medium for implementing the system (104), and for implementing particular system transactions. The memory element may also be utilized to implement databases (103, 1811d), such as for storing the general emission reduction credits inventory and the third party emission reduction credit accounts. The computing device also contains executable software, some of which may or may not be unique to the system (104).

In some embodiments, the system (104) is implemented in software, as an executable program, and is executed by one or more special or general purpose digital computer(s), such as a mainframe computer, a personal computer (desktop, laptop or otherwise), personal digital assistant, or other handheld computing device. Therefore, the computing device may be representative of any computer in which the system (104) resides or partially resides.

Generally, in terms of hardware architecture, the computing device includes a processor (1811a), a memory (1811b, 1811c), and one or more input and/or output (I/O) devices (or peripherals) that are communicatively coupled via a local interface. The local interface may be one or more buses or other wired or wireless connections, as is known in the art. The local interface may have additional elements, which are omitted for simplicity, such as controllers, buffers (caches), drivers, transmitters, and receivers to facilitate external communications with other like or dissimilar computing devices. Further, the local interface may include address, control, and/or data connections to enable internal communications among the other computer components.

The processor (1811a) is a hardware device for executing software, particularly software stored in memory. The processor (1811a) can be any custom made or commercially available processor, such as, for example, a Core series or vPro processor made by Intel Corporation, or a Phenom, Athlon or Sempron processor made by Advanced Micro Devices, Inc. In the case where the computing device is a server, the processor (1811a) may be, for example, a Xeon or Itanium processor from Intel, or an Opteron-series processor from Advanced Micro Devices, Inc. The processor (1811a) may also represent multiple parallel or distributed processors working in unison.

The memory (1811b, 1811c) can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. The memory (1811b, 1811c) can have a distributed architecture where various components are situated remote from one another, but are still accessed by the processor. These other components may reside on devices located elsewhere on a network or in a cloud arrangement.

The software in memory (1811b, 1811c) may include one or more separate programs. The separate programs comprise ordered listings of executable instructions for implementing logical functions. The software in memory (1811b, 1811c) may include the system (104) in accordance with the invention, and a suitable operating system (O/S). Examples of suitable commercially available operating systems are Windows operating systems available from Microsoft Corporation, Mac OS X available from Apple Computer, Inc., a Unix operating system from AT&T, or a Unix-derivative such as BSD or Linux. The operating system O/S will depend on the type of computing device. For example, if the computing device is a PDA or handheld computer, the operating system may be iOS for operating certain devices from Apple Computer, Inc., PalmOS for devices from Palm Computing, Inc., Windows Phone 8 from Microsoft Corporation, Android from Google, Inc., or Symbian from Nokia Corporation. The operating system essentially controls the execution of other computer programs, such as the system (104), and provides scheduling, input-output control, file and data management, memory management, and communication control and related services.

If the computing device is an IBM PC compatible computer or the like, the software in memory may further include a basic input output system (BIOS). The BIOS is a set of essential software routines that initialize and test hardware at startup, start the operating system, and support the transfer of data among the hardware devices. The BIOS is stored in ROM so that the BIOS can be executed when the computing device is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, and Lua. Components of the system (104) may also be written in a proprietary language developed to interact with these known languages.

An I/O device may include input devices such as a keyboard, a mouse, a scanner, a microphone, a touch screen, a bar code reader, or an infra-red reader. It may also include output devices such as a printer, a video display, an audio speaker or headphone port or a projector. The I/O device may also comprise devices that communicate with inputs or outputs, such as a short-range transceiver (RFID, Bluetooth, etc.), a telephonic interface, a cellular communication port, a router, or other types of network communication equipment. The I/O device may be internal to the computing device, or may be external and connected wirelessly or via connection cable, such as through a universal serial bus port.

When the computing device is in operation, the processor (1811a) is configured to execute software stored within the memory (1811b, 1811c), to communicate data to and from the memory (1811b, 1811c), and to generally control operations of the computing device pursuant to the software. The system (104) and the operating system, in whole or in part, may be read by the processor (1811a), buffered within the processor (1811a), and then executed.

In the context of this document, a “computer-readable medium” may be any means that can store, communicate, propagate, or transport data objects for use by or in connection with the system (104). The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system (104) can be embodied in any type of computer-readable medium for use by or in connection with an instruction execution system or apparatus, such as a computer.

For purposes of connecting to other computing devices, the computing device is equipped with network communication equipment and circuitry. In a preferred embodiment, the network communication equipment includes a network card such as an Ethernet card, or a wireless connection card. In a preferred network environment, each of the plurality of computing devices on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

The processor (1811a) is configured to request and receive information related to the emission reduction credits (101) in order to subscribe to a new green project. The processor (1811a) is configured to divide the emission reduction credits (101) into micro emission reduction credits (101-1), where the emission reduction credits (101) previously had been acquired in international carbon registry markets. Each emission reduction credit (101) may be connected to green projects around the world that reduce or avoid greenhouse gases. The processor (1811a) can create a portfolio with different percentages of emission reduction credits (101) and validate the cost of the emission reduction portfolio in order to calculate the profit of the portfolio. The processor (1811a) can send the emission reduction portfolio to a credit inventory which is part of the Sustainable Ad network system.

The processor (1811a) can identify a geographical/IP target for focusing the online advertising. The Sustainable Ad network system links the micro emission reduction credits (101-1) to any kind of online advertisement (105) in remote servers (1802, 1803, 1804) or computers (1805, 1806). Every time a person clicks, view or interacts with the advertisement, the Sustainable Ad network system automatically subtracts a micro emission reduction credit (101-1) from the reduction credits inventory (103) and adds, e.g., credits, a website emission reduction credit account (107), advertiser emission reduction credit account (108) or personal emission reduction credit account (109). The Sustainable Ad network system can send an alarm (110) via e-mail, tweet, SMS or other communication media (1810) if the credits inventory falls below a minimum threshold of micro emission reduction, such that new emission reduction credits (101) can be purchased.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method for trading an emission reduction credit between a processor and a website, the emission reduction credit associated with a green project traded on a carbon registry market, the method comprising:
assigning, using the processor, the emission reduction credit to a general emission reduction credits inventory stored in a database;
dividing, using the processor, the emission reduction credit into a plurality of micro emission reduction credits in the general emission reduction credits inventory;
linking, using the processor, the plurality of the micro emission reduction credits to an online advertisement displayed on the website, wherein the online advertisement comprises a logo;
receiving a selection of the online advertisement at the processor, the selection of the online advertisement comprising one or more of a click, a view, or an interaction with the online advertisement by a user; and
transferring, using the processor, one or more of the plurality of the micro emission reduction credits from the general emission reduction credits inventory to a third party emission reduction credit account stored in the database, in response to receiving the selection.

2. The method of claim 1, further comprising:
transmitting a request from the processor for information related to the emission reduction credit;
receiving the information related to the emission reduction credit at the processor, the information comprising one or more of a name, an identifier, a purchase date, a person responsible for purchase, an amount purchased, a total investment purchase, a cost per ton, a sales prices per ton, a provider, a vintage date, a standard, a carbon registry, a verifier, a green project type, a description, a country, a state, a longitude/latitude, an agreement, a picture, a video, or an acceptance and subscription; and
storing the information in the database.

3. The method of claim 1, wherein transferring comprises:
subtracting the one or more of the plurality of the micro emission reduction credits from the general emission reduction credits inventory, using the processor; and
adding the one or more of the plurality of the micro emission reduction credits to the third party emission reduction credit account, using the processor.

4. The method of claim 1, wherein the third party emission reduction credit account comprises one or more of a website emission reduction credit account, an advertiser emission reduction credit account, or a personal emission reduction credit account.

5. The method of claim 1, further comprising:
determining, using the processor, whether the general emission reduction credits inventory is below a minimum threshold; and
transmitting a notification alarm from the processor if the general emission reduction credits inventory is below the minimum threshold, the notification alarm comprising a message that the general emission reduction credits inventory is below the minimum threshold.

6. The method of claim 1, further comprising:
determining, using the processor, if the general emission reduction credits inventory is below a minimum threshold; and
purchasing the emission reduction credit associated with the green project at the carbon registry market, using the processor, if the general emission reduction credits inventory is below the minimum threshold.

7. The method of claim 1, further comprising:
transmitting the online advertisement from the processor to the website such that the online advertisement is targeted to a selected audience of users, based on one or more of a geographical area or an IP address.

8. The method of claim 1, wherein the online advertisement comprises a logo, the method further comprising:
receiving a selection of the logo at the processor, the selection of the logo comprising one or more of a click, a view, or an interaction with the logo by the user; and
transmitting information related to the micro emission reduction credits account from the processor to the online advertisement, the information stored in the database and comprising one or more of an amount of the micro emission reduction credits, or climate benefits of the online advertisement.

9. The method of claim 1, wherein the website comprises a logo, the logo comprising a URL for an emission statistics webpage, and the third party emission reduction credit account comprises a website emission reduction credit account, the method further comprising:
receiving a selection of the logo at the processor, the selection of the logo comprising one or more of a click, a view, or an interaction with the logo by the user; and
transmitting, from the processor, the emission statistics webpage associated with the website emission reduction credit account, the emission statistics webpage stored in the database and comprising an amount of the micro emission reduction credits accumulated by the website.

10. The method of claim 1, wherein the third party emission reduction credit account comprises an advertiser emission reduction credit account, the method further comprising:
transmitting a webpage banner from the processor for display on the website, the webpage banner comprising one or more of an amount of the micro emission reduction credits accumulated for an online advertising campaign related to the online advertisement, or climate benefits of the online advertising campaign;
receiving a selection of the webpage banner at the processor, the selection of the webpage banner comprising one or more of a click, a view, or an interaction with the webpage banner by the user, the webpage banner comprising a URL for an advertiser emission statistics webpage; and
transmitting, from the processor, the advertiser emission statistics webpage associated with the advertiser emission reduction credit account, the advertiser emission statistics webpage stored in the database and comprising an amount of the micro emission reduction credits accumulated by an advertiser.

11. The method of claim 1, further comprising:
calculating, using the processor, a first percentage of a credits portfolio based on the cost of the emission reduction credit, and a second percentage of the credits portfolio based on the cost of a second emission reduction credit, the second emission reduction credit associated with a second green project; and
creating, using the processor, the credits portfolio in the general emission reduction credits inventory, the credits portfolio comprising the first percentage of the emission reduction credit and the second percentage of the second emission reduction credit; and
wherein:
dividing comprises dividing, using the processor, the credits portfolio into the plurality of micro emission reduction credits in the general emission reduction credits inventory; and
linking comprises linking, using the processor, the credits portfolio to the online advertisement displayed on the website.

12. The method of claim 11, wherein the credits portfolio is linked with one or more of a geographical area or an IP address, the method further comprising:
placing the online advertisement on the website such that the online advertisement is targeted to a selected audience of users in the geographical area or the IP address.

13. A method for trading an emission reduction credit between a processor and a website, the emission reduction credit associated with a green project traded on a carbon registry market, the method comprising:
creating a third party emission reduction credit account stored in a database, comprising one or more of a website emission reduction credit account, an advertiser emission reduction credit account, or a personal emission reduction credit account;
linking, using the processor, the website to the website emission reduction credit account;
associating, using the processor, an online advertisement to the website;
transmitting, using the processor, the online advertisement on the website;
receiving a selection of the online advertisement at the processor, the selection of the online advertisement comprising one or more of a click, a view, or an interaction with the online advertisement by a user; and
transferring, using the processor, one or more of a plurality of micro emission reduction credits from a general emission reduction credits inventory to the website emission reduction credit account, wherein:
the general emission reduction credits inventory is stored in the database; and
the plurality of micro emission reduction credits is derived from the emission reduction credit in the general emission reduction credits inventory.

14. The method of claim 13:
further comprising linking, using the processor, an advertiser to the advertiser emission reduction credit account; and
wherein:
associating comprises associating, using the processor, the online advertisement of the advertiser to the website; and
transferring comprises transferring, using the processor, one or more of the plurality of micro emission reduction credits from the general emission reduction credits inventory to the advertiser emission reduction credit account.

15. The method of claim 14, wherein:
associating comprises associating, using the processor, the online advertisement of the advertiser to the personal emission reduction credit account; and
transferring comprises transferring, using the processor, one or more of the plurality of micro emission reduction credits from the general emission reduction credits inventory to the personal emission reduction credit account.

16. The method of claim 15, wherein transferring comprises:
subtracting the one or more of the plurality of the micro emission reduction credits from the general emission reduction credits inventory, using the processor; and
adding the one or more of the plurality of the micro emission reduction credits to the third party emission reduction credit account, using the processor.

17. The method of claim 13, wherein transmitting comprises transmitting the online advertisement to the website such that the online advertisement is targeted to a selected audience of users, based on one or more of a geographical area or an IP address.

18. The method of claim 13, wherein the plurality of micro emission reduction credits is derived from a credits portfolio, the credits portfolio based on a first percentage of the emission reduction credit and a second percentage of a second emission reduction credit in the general emission reduction credits inventory, the second emission reduction credit associated with a second green project.

19. The method of claim 18, wherein the credits portfolio is linked with one or more of a geographical area or an IP address, the method further comprising:
placing the online advertisement on the website such that the online advertisement is targeted to a selected audience of users in the geographical area or the IP address.

20. The method of claim 13, further comprising:
determining, using the processor, whether the general emission reduction credits inventory is below a minimum threshold; and
transmitting a notification alarm from the processor if the general emission reduction credits inventory is below the minimum threshold, the notification alarm comprising a message that the general emission reduction credits inventory is below the minimum threshold.
